(19) United States
(12) Patent Application Publication
(10) Pub. No.: US 2017/0331142 A1
(43) Pub. Date: Nov. 16, 2017

(54) RECHARGEABLE BATTERY, COOLING SYSTEM THEREFOR AND METHOD OF MANUFACTURE

(71) Applicant: JAGUAR LAND ROVER LIMITED, Whitley,Coventry,Warwickshire (GB)

(72) Inventor: Stephen NICHOLLS, Witney, Oxfordshire (GB)

(21) Appl. No.: 15/528,785

(22) PCT Filed: Nov. 20, 2015
(86) PCT No.: PCT/EP2015/077224

§ 371 Date: May 23, 2017

(30) Foreign Application Priority Data
Nov. 24, 2014 (GB) 1420823.5

(51) Int. Cl. H01M 10/04; H01M 10/643; H01M 10/625; B60L 11/18; H01M 10/613

(52) U.S. Cl. CPC H01M 10/0422; B60L 11/18; H01M 10/613; H01M 10/625; H01M 10/643

(57) ABSTRACT

A rechargeable cell having an outer casing and a roll including layers of active and insulator material disposed within the outer casing. The rechargeable cell additionally includes an externally accessible hollow core which enables central cooling of the rechargeable cell.

### TECHNICAL FIELD

The present disclosure relates to rechargeable cells, to systems for cooling one or more such rechargeable cells and to methods of manufacture of a rechargeable cell. Additionally the disclosure relates to a core insert for a rechargeable cell and to a rechargeable cell comprising such a core insert. Furthermore the disclosure relates to a battery pack comprising a plurality of rechargeable cells, a cooling system for the same and a vehicle comprising such a battery pack and such a cooling system. More particularly, but not exclusively, the disclosure relates to rechargeable cylindrical cells that are centrally cooled. Embodiments of the invention find advantageous application in a wide variety of applications where rechargeable batteries and/or battery packs are utilized in particular, but not exclusively, in electric vehicles (EVs) and hybrid electric vehicles (HEVs).

Aspects of the invention relate to a rechargeable cell, to a system for cooling one or more such rechargeable cells, to methods of manufacture of a rechargeable cell, to a core insert for a rechargeable cell, to a cooling apparatus, to a battery pack comprising a plurality of rechargeable cells and to a vehicle.

### BACKGROUND

Rechargeable cylindrical cells (referred to simply as cylindrical cells) are popular for a wide variety of applications. A popular Lithium Ion rechargeable cylindrical cell is the well-known 18650 cylindrical cell (named because of its 18 mm diameter and 65 mm height). Such, and similar, cylindrical cells comprise a cylindrical roll of material sealed within an enclosed outer casing. The cylindrical roll is formed by rolling up a length of layered material that typically comprises two layers of active material separated by two layers of insulating material (also referred to as a separator material). Typically a conductive tab connected at one end of a layer of active material provides a negative connection for the negative terminal of the rechargeable cylindrical cell and this is electrically connected to the base of the outer casing. Typically an electrical connection to the other end of the other layer of active material is electrically connected to a cap, which closes off the outer casing and provides the positive terminal. The cap also typically houses a current interrupt device (CID) which serves to protect the cylindrical cell from overcharging.

Such cylindrical cells beneficially offer a greater energy density compared to other designs of rechargeable cell, such as prismatic cells and pouch cells. Disadvantageously however, such cylindrical cells can be challenging to cool because of the very low external surface area available for dissipation of heat energy. Furthermore, despite the uniform shape and even heat transfer associated with cylindrical cells, the center of the cell, which is furthest from the external surfaces, is typically the hottest part of the cylindrical cell. Heating is an important factor affecting the lifetime (sometimes measured in numbers of discharge cycles) of a rechargeable cell. When a high electrical demand is suddenly placed on a cylindrical cell it can heat up quickly, the central region of the cell can become hot, and this can have a deleterious effect on the lifetime of the cell. As such, though cylindrical cells offer a greater energy density, their use in certain applications is limited or is not viable.

The present invention seeks to provide an improvement in the field of rechargeable cylindrical cells. Whilst rechargeable cylindrical cells and other aspects of the present disclosure have particular application in EVs and HEVs, cylindrical cells according to the disclosure may nevertheless be utilized in applications other than for vehicles.

### SUMMARY OF THE INVENTION

Aspects of the invention provide a rechargeable cylindrical cell, a system for cooling one or more such rechargeable cylindrical cells, methods of manufacture of a rechargeable cylindrical cell, a core insert for a rechargeable cylindrical cell, a cooling apparatus, a battery pack comprising a plurality of rechargeable cylindrical cells and a vehicle as claimed in the appended claims.

According to an aspect of the invention for which protection is sought, there is provided a rechargeable cell comprising an outer casing, a roll and a protective cap fitted onto the top of the outer casing, the roll comprising layers of active and insulator material disposed within the outer casing, wherein an active layer of material of said roll is electrically connected to a positive terminal within the protective cap, the rechargeable cell additionally comprising an externally accessible hollow core which enables central cooling of the rechargeable cell, the hollow core being externally accessible by means of an aperture in a base of the outer casing opposite the protective cap and a core insert. Beneficially, therefore, the rechargeable cell can be centrally cooled.

Optionally, the roll and/or the outer casing are at least substantially cylindrical in shape, such that the rechargeable cell is a rechargeable cylindrical cell.

Optionally the roll, comprising layers of active and insulator material, is formed around part of the core insert.

Optionally, the core insert is formed of an electrically conductive material; the core insert is electrically connected to an active layer of material of said roll not electrically connected to the positive terminal and the core insert provides a negative electrode of the rechargeable cylindrical cell. Such an arrangement may benefit from a lower electrical resistance.

Optionally the roll, comprising layers of active and insulator material, is formed around a mandrel such that the roll comprises a central bore and wherein part of the core insert is inserted into that central bore and is not electrically connected to any layer of the roll.

Optionally, the core insert comprises an elongate member and an insert base, wherein the elongate member is disposed in a central bore of said roll, and wherein the insert base is affixed to the base of the outer casing to seal the roll within the outer casing whilst facilitating access to the externally accessible hollow core thereby formed.

Optionally, the elongate member is generally cylindrical and hollow, and is closed at an upper end thereof.

Optionally, the upper end of the elongate member is crimped closed.

Optionally, the core insert is formed from the same material as the outer casing of the rechargeable cell.

Optionally, the core insert is formed from steel.

Optionally, the insert base is welded to the base of the outer casing.

Optionally the core insert is formed, at least in part, from a plastics material.

According to another aspect of the disclosure for which protection is sought, there is provided a battery pack comprising a plurality of rechargeable cylindrical cells according to any of the relevant preceding paragraphs.

According to a further aspect of the disclosure for which protection is sought, there is provided a system for cooling a rechargeable cell having an externally accessible hollow core, the system comprising at least one finger configured and arranged for insertion at least partially into said externally accessible hollow core of a rechargeable cell, said at least one finger comprising a first pathway for an inbound flow of coolant and a second pathway for an outbound flow of coolant.

Optionally, the coolant is a coolant liquid or a gas and the first pathway provides for the supply of cooled coolant into the finger, and the second pathway provides for the extraction of heated coolant from the finger.

Optionally, the first pathway is disposed innermost of the finger and the second pathway is disposed outermost of the finger.

Optionally, the second pathway has an annular cross-sectional shape.

Optionally, the first pathway comprises an open upper end, and the second pathway comprises an open upper end such that the inbound flow of coolant can be pumped through the first pathway, and such that the outbound flow of coolant is pumped out through the second pathway and adjacent to the walls of the hollow core.

Optionally, the system is for cooling a battery pack comprising a plurality of rechargeable cells and the system comprises a plurality of fingers, each for being at least partially inserted into a hollow core of one of the rechargeable cells.

Optionally, the plurality of fingers are arranged to optimize nesting of adjacent rechargeable cells.

Optionally, the plurality of fingers are arranged in diagonal rows such that the rechargeable cells can nest in a honeycomb style arrangement.

According to yet another aspect of the disclosure for which protection is sought, there is provided a cooling apparatus for use in a system for cooling a plurality of rechargeable cells each having an externally accessible hollow core. The cooling apparatus comprises a block of heat conductive material and comprises a plurality of bores, each bore for receiving one of said plurality of rechargeable cells. The plurality of bores are arranged to optimize nesting of adjacent rechargeable cells, wherein a distance (spacing) between adjacent bores is less than or equal to about 0.5 mm. In other words the distance between the center point of one bore and the center point of an adjacent bore may be spaced apart by a distance that is less than or equal to about 18.5 mm.

According to yet a further aspect of the disclosure for which protection is sought, there is provided a vehicle comprising a battery pack and a system for cooling said battery pack.

According to yet even another aspect of the disclosure for which protection is sought, there is provided a core insert for a rechargeable cell comprising a roll comprising layers of active and insulator material disposed within an outer casing, the core insert comprising an elongate member and an insert base, the elongate member being configured such that it can be disposed in a central bore of said roll, the insert base being affixable to a base of the outer casing for sealing said roll within the outer casing whilst facilitating access to an externally accessible hollow core thereby formed to enable central cooling of the rechargeable cell.

Optionally, the elongate member is generally cylindrical and hollow, and is closed at an upper end thereof.

Optionally, the upper end of the elongate member is crimped closed.

Optionally, the core insert is formed from metal or plastics material.

Optionally, the elongate member and the insert base of the core insert are a unitary construct.

According to yet even a further aspect of the disclosure for which protection is sought, there is provided a method of manufacture of a rechargeable battery cell, the method comprising:
(i) connecting a core insert to an active layer of a material comprising layers of active and insulator material; and
(ii) winding said material about the core insert to form a roll and integral core insert.

Optionally, the core insert has an elongate member that is closed at a first end thereof and has a base portion at a second end thereof and the method further comprises:
(i) inserting said roll and core insert, together as a single unit, into an outer casing having an aperture in a base thereof, such that the base portion of the core insert passes through said aperture; and
(ii) affixing the base portion of the core insert to the base of the outer casing to seal said roll within the outer casing and to form an externally accessible hollow core which enables central cooling of the rechargeable cell.

According to another further aspect of the present disclosure for which protection is sought, there is provided a method of manufacture of a rechargeable battery cell, the method comprising:
(i) providing an outer casing having a base comprising an aperture;
(ii) positioning a roll of material comprising layers of active and insulator material into the outer casing;
(iii) inserting part of a core insert, having an elongate member and an insert base, into a central core of the roll; and
(iv) affixing said insert base to the base of the outer casing to form an externally accessible hollow core which enables central cooling of the rechargeable cell.

Within the scope of this application it is expressly intended that the various aspects, embodiments, examples and alternatives set out in the preceding paragraphs, in the claims and/or in the following description and drawings, and in particular the individual features thereof, may be taken independently or in any combination. That is, all embodiments and/or features of any embodiment can be combined in any way and/or combination, unless such features are incompatible. The applicant reserves the right to change any originally filed claim or file any new claim accordingly, including the right to amend any originally filed claim to depend from and/or incorporate any feature of any other claim although not originally claimed in that manner.

### BRIEF DESCRIPTION OF THE DRAWINGS

One or more embodiments of the invention will now be described, by way of example only, with reference to the accompanying drawings, in which:

FIG. 1A is a schematic representation of a view through the center of a rechargeable cell according to an embodiment of the invention;

FIG. 1B is a schematic representation of a view through the center of the rechargeable cell of FIG. 1A, wherein the roll of active and insulator material has been removed to show more clearly an externally accessible hollow core of the rechargeable cell;

FIG. 2A is a plan view of the bottom of the rechargeable cell of FIGS. 1A and 1B;

FIG. 2B is a perspective view of a core insert used to form a rechargeable cell according to various embodiments of the invention;

FIG. 3 is a cross-sectional view of part of a cooling system for use with rechargeable cells as shown in FIGS. 1A, 1B and 2A;

FIG. 4 is a cross-sectional view of the cooling system shown in FIG. 3 and part of a rechargeable cell according to various embodiments, mounted therein and being centrally cooled using its externally accessible central core;

FIG. 5A is a plan view of a cooling apparatus for use in a cooling system such as that shown in FIG. 4;

FIG. 5B is a perspective, partially cut away view of a cooling apparatus for use in a cooling system such as that of FIG. 4, wherein a plurality of rechargeable cells have been mounted within the apparatus with fingers of the cooling system disposed within the externally accessible hollow core of each rechargeable cell;

FIG. 6 is an illustration of part of a first method of manufacture of a rechargeable cell, wherein a perspective illustration of a piece of active material being electrically connected to, and about to be wound around, a core insert is shown;

FIG. 7 is a schematic illustration of part of a second method of manufacture of a rechargeable cell; and

FIG. 8 is an electric vehicle comprising a battery pack and a cooling system according to various embodiments of the disclosure.

### DETAILED DESCRIPTION OF EMBODIMENTS

Detailed descriptions of specific embodiments of the rechargeable cells, battery packs, methods, core inserts, cooling systems and cooling apparatus of the present invention are disclosed herein. It will be understood that the disclosed embodiments are merely examples of the way in which certain aspects of the invention can be implemented and do not represent an exhaustive list of all of the ways the invention may be embodied. Indeed, it will be understood that the rechargeable cells, battery packs, methods, core inserts, cooling systems and cooling apparatus described herein may be embodied in various and alternative forms. The Figures are not necessarily to scale and some features may be exaggerated or minimized to show details of particular components. Well-known components, materials or methods are not necessarily described in great detail in order to avoid obscuring the present disclosure. Any specific structural and functional details disclosed herein are not to be interpreted as limiting, but merely as a basis for the claims and as a representative basis for teaching one skilled in the art to variously employ the invention.

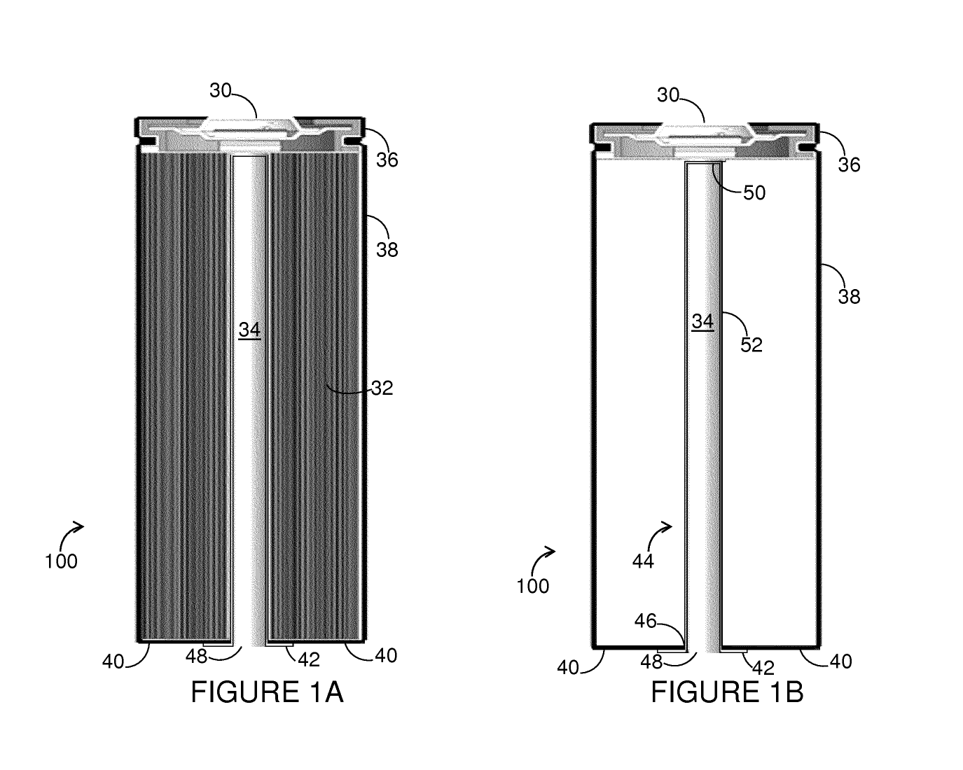

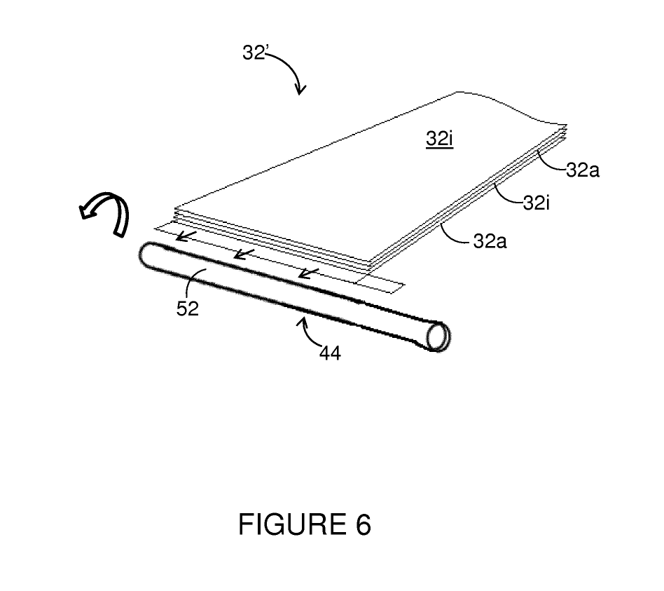

In FIG. 1A there is shown a rechargeable cell 100 according to an optional illustrated embodiment. The rechargeable cell 100 has a generally cylindrical structure and may be referred to as a “cylinder cell”. The rechargeable cell 100 comprises an outer casing 38 (also referred to as a “can” 38), which is optionally a press-formed steel structure which houses and protects the internal features of the rechargeable cell 100. Within the outer casing 38, the rechargeable cell 100 comprises a roll 32 comprising layers of active and insulator material. The roll 32 is sometimes referred to as a “jelly roll” 32 and, as illustrated in FIG. 6, optionally comprises four layers of material: two layers of separator, insulator material 32i alternated between two active layers of material 32a. The active layers of material 32a may be formed from thin copper strips, printed with active material. The four layers are sandwiched or laminated and rolled, optionally about a cylindrical mandrel, to create a roll 32 of material of annular cross-section and having a hollow, central bore.

An electrical connection between one of the active layers of material 32a is connected to a positive terminal 30 disposed within a protective cap 36 fitted onto the top of the can 38. A further electrical connection between the other one of the active layers of material 32a and the base 40 of the outer casing 38 provides a negative terminal.

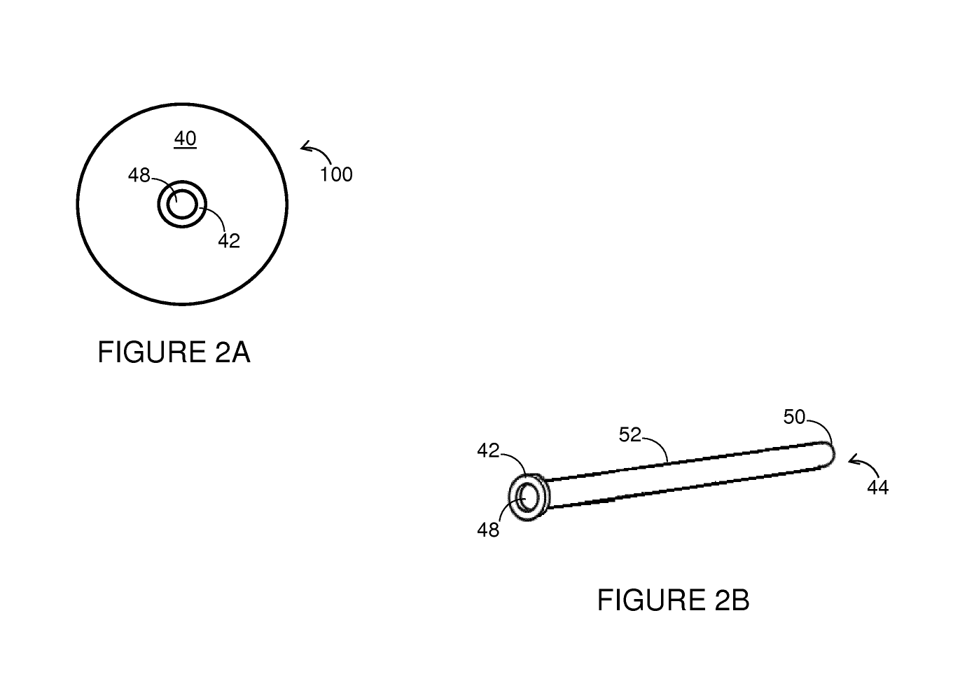

The rechargeable cell 100 additionally comprises an externally accessible hollow core 34 by which the rechargeable cell 100 can be centrally cooled. In FIG. 1B, the jelly roll 32 has been removed in order to more clearly illustrate the externally accessible hollow core 34. The hollow core 34 in the present embodiment is formed from a core insert 44 (see FIG. 2B). The core insert 44 comprises an elongate member 52 that is sufficiently rigid to define the hollow core 34 and to protect the jelly roll 32 disposed inside the rechargeable cell 100. The hollow core 34 is externally accessible because a base 40 of the outer casing 38 has an aperture 46 therein which is aligned with the core insert 44 defining the hollow core 34.

The roll 32 and the outer casing 38 have a substantially cylindrical outer shape, such that the rechargeable cell 100 may be referred to as a cylindrical cell. The inclusion of the hollow core 34 has the effect of forming a region of the rechargeable cell 100 having an annular or ring shaped cross section.

The core insert 44 forming the hollow core 34 in the present embodiment is a separate piece to the outer casing 38 (see FIG. 2B) and is affixed to a base 40 of the outer casing 38, as shown in plan view in FIG. 2A. The core insert 44 additionally comprises a closed upper end 50. The closed upper end 50 may be formed simply by crimping the ends of the elongate tube member 52. The core insert 44 further comprises an insert base 42 which is provided for affixing the core insert 44 to the base 40 of the outer casing 38. An aperture 48 within the insert base 42 allows the hollow core 34 to be externally accessible.

In the present arrangement, the core insert 44 is formed from the same material as the outer casing 38 of the rechargeable cell 100. The outer casing 38 and the core insert 44 are optionally both formed from steel. As such, once the elongate member 52 is disposed within the central bore of said roll 32, the insert base 42 is affixed to the base 40 of the outer casing 38 to seal the roll 32 within the outer casing 38 whilst facilitating access to the externally accessible hollow core 34 thereby formed. The insert base 42 is optionally welded to the base 40 of the outer casing 38 to ensure that the outer casing 38 and core insert 44 form a sealed unit which encases the roll 32. In alternative embodiments the core insert 44 is formed, at least in part, from a plastics material.

The provision of an externally accessible lined, hollow core 34 within the rechargeable cell 100 provides a means by which the rechargeable cell 100 can be centrally cooled. The central cooling of the rechargeable cell 100 may be carried out instead of, or in conjunction with, cooling of the external outer surface of the rechargeable cell 100 (generally defined by the outer casing 38). The capability of cylindrical rechargeable cells 100 to be centrally cooled permits the rechargeable cells 100 of the present disclosure to be more widely used and used in applications where traditional cylindrical cells could not be used because of the challenges associated with cooling them. Additionally, rechargeable cells 100 of the present disclosure may be formed in larger sizes than traditional cylindrical, non-centrally cooled cells could be made.

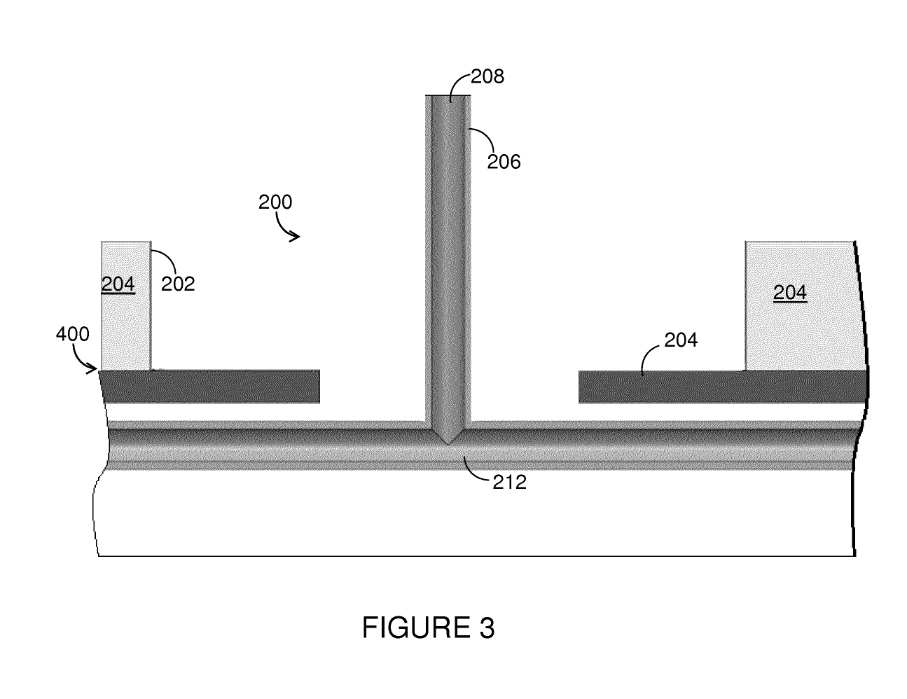

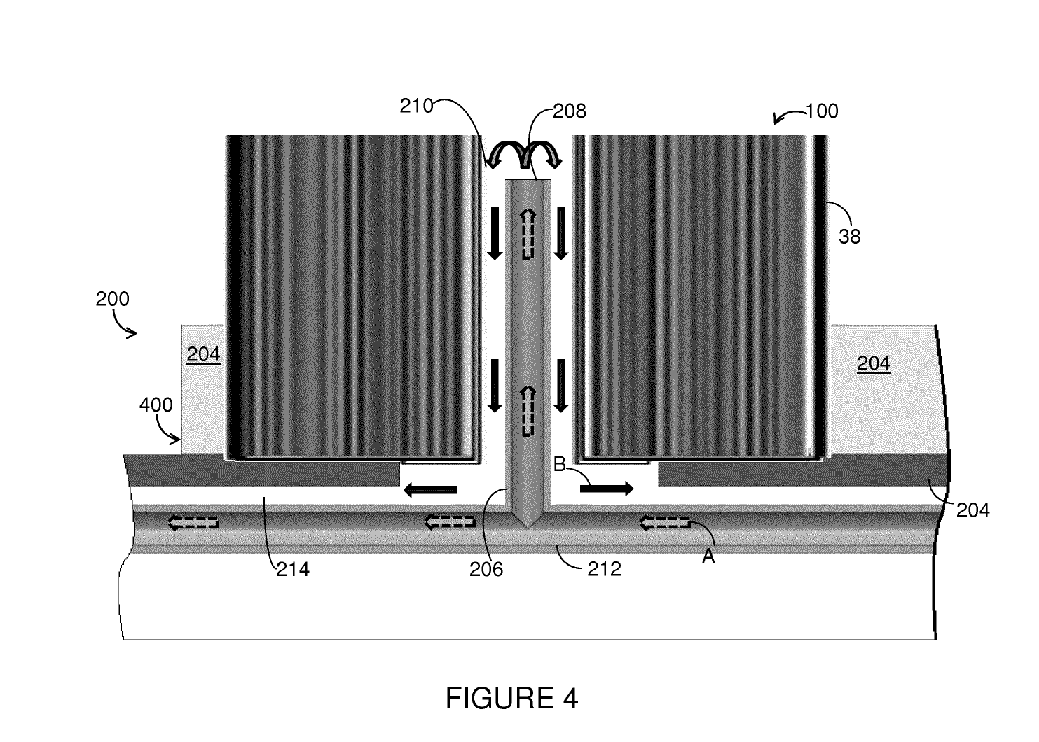

In FIG. 3, a cooling system 200, which forms another aspect of the present disclosure, is shown. The cooling system 200 optionally comprises a cooling apparatus 400 in the form of a block 204 having bores 202 formed therein into which one or more rechargeable cells 100 can be mounted (see FIG. 4). The cooling system 200 additionally comprises at least one finger 206 configured and arranged for insertion at least partially into the externally accessible hollow core 34 of a rechargeable cell 100 (see FIG. 4). The at least one finger 206 comprises a first pathway 208 for an inbound flow of coolant and defines a second pathway 210 for an outbound flow of coolant. As shown in the optional illustrated arrangement, the first pathway 208 is disposed innermost of the finger 206 and the second pathway 210 is disposed on the outside of the finger 206. The second pathway 210 may be defined by an outer surface of the finger 206 and a surface of the hollow core 34 of the rechargeable cell 100. As such, the second pathway 210 has an annular cross-sectional shape.

As shown in FIG. 4, the first pathway 208 comprises an open upper end and the second pathway 210 comprises an open upper end such that the inbound flow of coolant can be pumped through the first pathway 208 and into the second pathway 210 adjacent to walls of the hollow core 34 for extracting heat energy from the center of the rechargeable cell 100. This is best seen in FIG. 4, wherein the flow of coolant is illustrated by arrows. Dashed grey arrows (A) have been used to schematically illustrate an optional flow path for inbound cool coolant supplied by conduit 212 and solid darker arrows (B) have been used to schematically illustrate an optional flow path for outbound heated coolant which is extracting heat from the core of the rechargeable cell 100 in route or conduit 214. As such the second pathway 210 for the outbound flow of coolant may be defined by the core insert 34 itself and channels within the cooling apparatus 400. The outer case 38 is affixed to the block 204 in this arrangement in order to seal the coolant within the cooling system 200 and to prevent cooling fluid leaking out of the cooling areas.

In other embodiments the system for cooling a rechargeable cell 100 comprises a finger having one or more additional pipes or conduits for the outbound flow of coolant and/or a cooling apparatus 400 having one or more additional pipes or conduits for the outbound flow of coolant.

The coolant may be a coolant liquid or a gas. The coolant is circulated, optionally by pumping throughout the system, and passes a heat exchanger (not shown) which extracts heat energy from the coolant before re-circulating the coolant back into the first pathway for continually supplying cooled coolant into the finger 206 and hence into the hollow core 34 of the rechargeable cell 100.

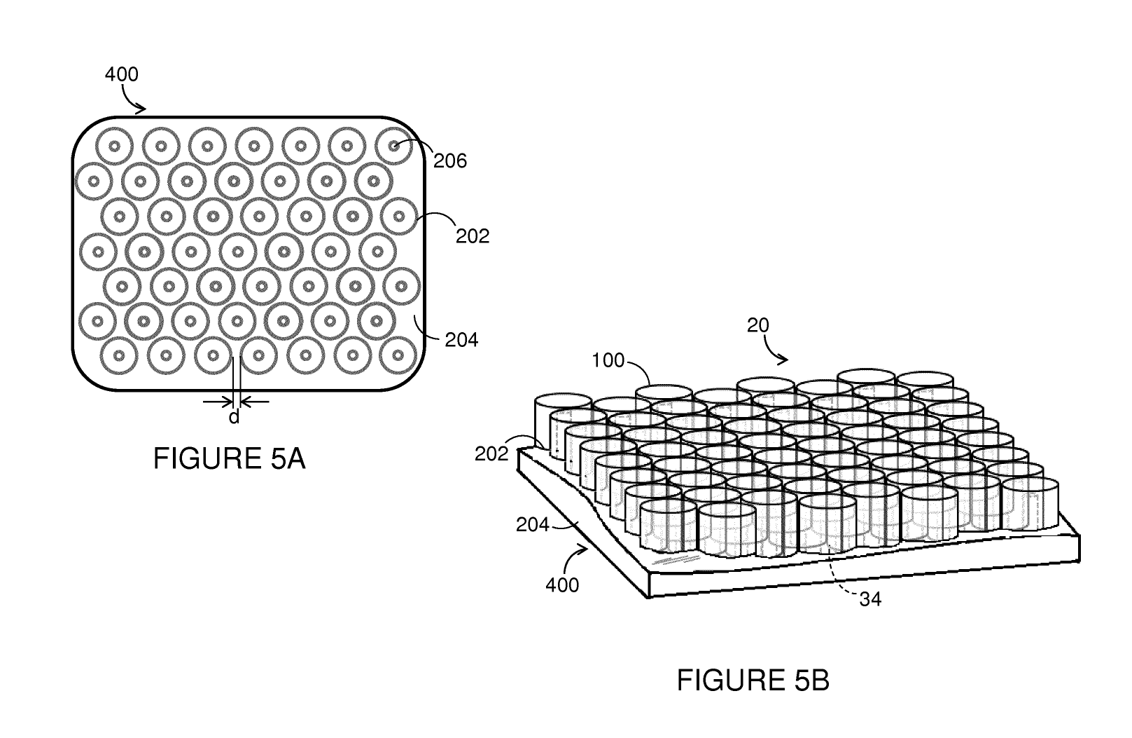

The system 200 may comprise a plurality of fingers, each for being at least partially inserted into a hollow core 34 of one of a plurality of rechargeable cells 100. A cooling apparatus 400 and a plurality of fingers 206 of such a cooling system 200 are shown schematically in plan view in FIG. 5A. It can be seen that the apparatus 400 is a substantially solid block 204 into which a plurality of bores 202 have been formed, each sized for receiving a rechargeable cell 100 and a finger 206. Due to central cooling of the rechargeable cells 100, the rechargeable cells 100 can be tightly packed or tightly nested. As such a plurality of fingers 206 of a cooling system 200 and a plurality of bores 202 of a cooling apparatus 400 are arranged to optimize nesting of adjacent rechargeable cells 100. In an optional arrangement the plurality of fingers 206 of the cooling system 200 and the plurality of bores 202 in the block 204 are arranged substantially in diagonal rows or otherwise arranged such that the rechargeable cells 100 can nest in a honeycomb style arrangement (see FIG. 5A).

The cooling apparatus 400 for use in a system 200 for cooling a plurality of rechargeable cells 100 comprises a block 204 of heat conductive material such as, but not limited to, aluminium. As discussed and shown in FIG. 5A, the plurality of bores 202 are arranged to optimize nesting of adjacent rechargeable cells 100 and because the block 204 is not relied upon for significant external cooling of the rechargeable cells 100, an average or a maximum distance ‘d’ between adjacent bores 202 is less than or equal to about 0.5 mm. In other words the distance between the center point of one bore and the center point of an adjacent bore may be less than or equal to about 18.5 mm.

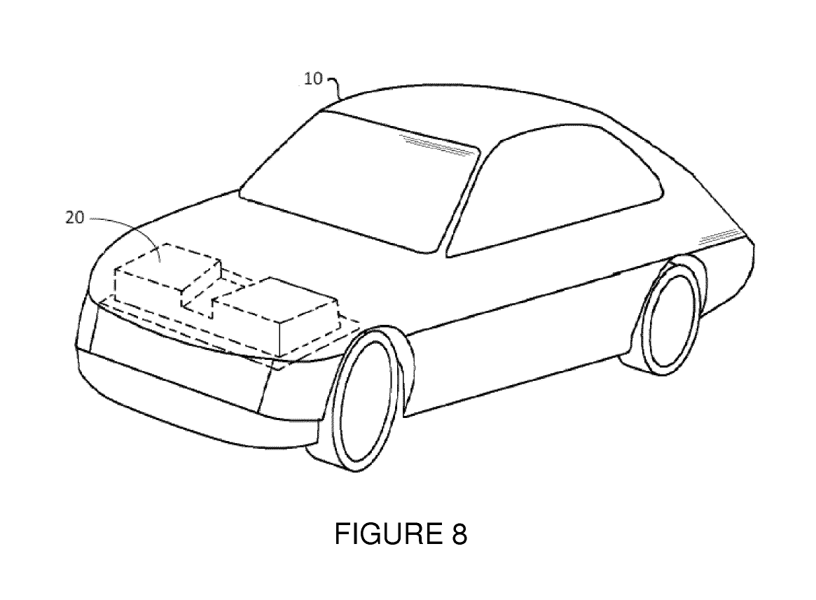

The rechargeable cell 100 of the present disclosure may be advantageously utilized in the formation of a rechargeable battery pack 20 (see FIG. 5) comprising a plurality of rechargeable cells 100. As shown in FIG. 8, a rechargeable battery pack 20 may find advantageous application in a vehicle 10, such as an EV or an HEV. A rechargeable battery pack 20 according to an aspect of the disclosure is formed in combination with a cooling apparatus 400 of a cooling system. Referring now to FIG. 5B, there is shown a perspective illustration of a nested, optionally honeycomb style arrangement of a plurality of cells 100 each disposed in an individual bore 202 formed within a block 204 of a cooling apparatus 400. For illustrative purposes, the block 204 has been cut away to more clearly show the arrangement of rechargeable cells 100 therein. Again, because the block 204 is not relied upon for significant external cooling of the rechargeable cells 100, due to the provision of central cooling, an average or a maximum distance ‘d’ between adjacent bores 202 is less than or equal to about 0.5 mm. In other words the distance between the center point of one bore and the center point of an adjacent bore may be less than or equal to about 18.5 mm.

As discussed above, the rechargeable cells 100 disclosed herein are formed with an internal hollow core 34 that is accessible externally of the rechargeable cell 100 such that the contents of the cell 100 remain encased and protected and such that the rechargeable cell 100 can be centrally cooled. In an embodiment of the disclosure, the rechargeable cells 100 are formed using a method of manufacture as illustrated in FIG. 6. In such an arrangement, a core insert 44 forms the mandrel about which the jelly roll 32 is formed. The core insert may be (electrically or conductively) connected to an active layer 32a of the material 32′ used to form the jelly roll 32, as shown by straight arrows in FIG. 6. Then, the material 32′ is wound about the core insert 44, as shown by the curled arrow in FIG. 6 to form a roll 32 having an integral core insert 44. The core insert in such a method is effectively a core liner which also serves as the mandrel. Beneficially, such a method obviates the step of removing a separate mandrel and further beneficially provides an improved electrical connection to the negative terminal of the jelly roll 32 which may improve (reduce) the electrical resistance of the rechargeable cell 100.

As shown in FIG. 6, and as described above, the core insert 44 has an elongate member 52 that is closed at a first end 50 and that initially is substantially straight at a second open end. Forming a rechargeable cell 100 further comprises inserting the jelly roll with the core insert 44 integrally formed therein, together as a single unit, into the outer casing 38. The base 40 of the outer casing 38 has an aperture 46 formed therein, such that the insert base 42 of the core insert 44 passes through said aperture 46 (as shown in FIG. 1B). Finally, the insert base 42 (also referred to as the base portion 42 of the core insert 44) is formed by pressing and/or bending a section of the open end of the core insert 44, which base portion 42 is then affixed, optionally by welding, such as laser welding, to the base of the outer casing 38 to seal the roll 32 within the outer casing 38 to form a rechargeable cell 100 having an externally accessible hollow core 34.

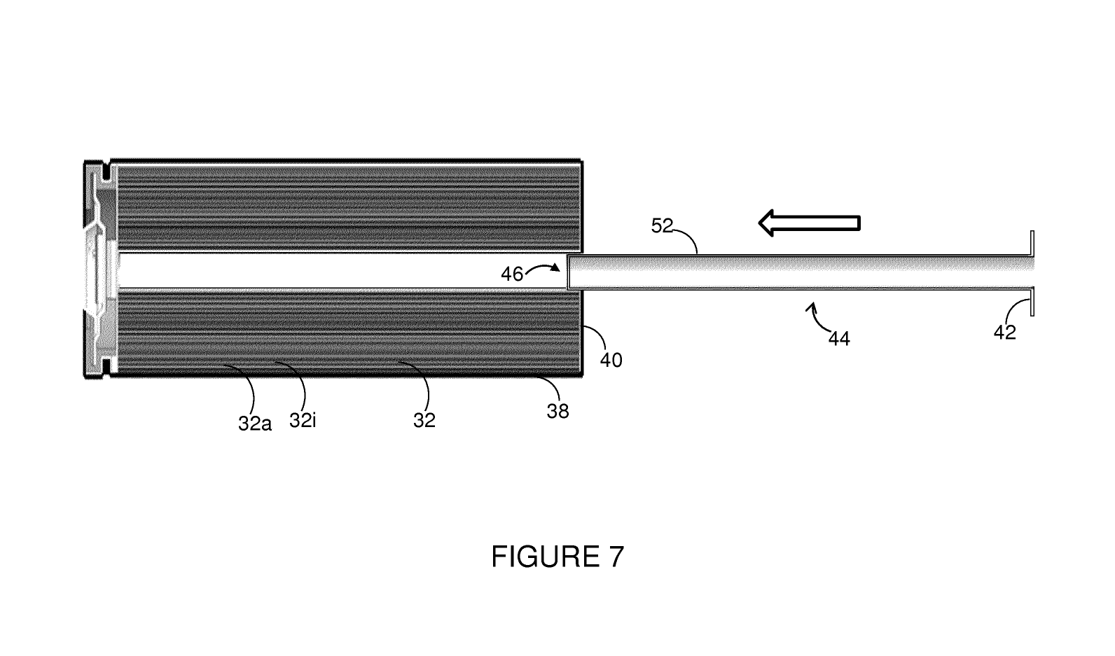

Referring now to FIG. 7, there is illustrated a further embodiment of a method of manufacture of a rechargeable battery cell 100. In this method, an outer casing 38 is provided which has a base 40 which comprises an aperture 46. The aperture may be punched, pressed or cut out of a solid base 40. Alternatively the outer casing 38 may be formed with an aperture 46 already therein. The roll of material 32, comprising layers of active 32a and insulator 32i material, is placed into the outer casing 38. Then part of a core insert 44 having an elongate member 52 and an insert base 42 is inserted into a central core of the jelly roll 32. The insertion of the jelly roll 32 is achieved by relative movement of the core insert 44 and outer casing 38 (see FIG. 7). In other words, the core insert 44 may be pushed into the outer casing 38 and/or the outer casing 38 may be placed onto the core insert 44. Finally, the insert base 42 is affixed, optionally by welding or other means to the base 40 of the outer casing 38 to form a rechargeable cell 100 having an externally accessible hollow core 34.

It can be appreciated that various changes may be made within the scope of the present invention. For example, in other embodiments of the invention it is envisaged that an outer casing may be formed that has within it an integral core insert or core liner such that a region of the outer casing has an annular cross section. In such an arrangement, the jelly roll will be deposited into the outer casing, the bore of the roll 32 slotting over the integral core insert.

Whereas specific mention has been made of the known 18650 cylindrical cells, the rechargeable cells of the present disclosure may be formed in a wide range of diameters and heights and the rechargeable cells of the present disclosure are in no way limited to having an 18 mm diameter and a 65 mm height.

The term “rechargeable cell” as used herein is intended to refer to rechargeable cells wherein the layers of active and separator material are wound or coiled and formed into a substantially uniform roll, typically having a cylindrical shape, which is packed into an outer casing having a similar, substantially cylindrical shape. It will be appreciated, however, that the shape of the uniform roll created is governed by the shape of a mandrel, or other device, about which the roll is formed. As such, the term “rechargeable cell”, as used herein may, where appropriate, also refer to non-cylindrical shapes of cell containing a packaged roll of active and separator material such as, but not limited to, elliptical, stadium-shaped, triangular, rounded triangular, square, rounded square, pentagonal, rounded pentagonal, hexagonal, rounded hexagonal and other polygonal and/or rounded polygonal shapes, if suitable. Aspects of the present disclosure have particular benefit to such rechargeable cells where as a result of the tightly packed roll of active and insulator material, heat build-up in the center of the cell can present a problem. The modifications and/or improvements described herein provide rechargeable cells containing a roll of material with the advantage of having the capability to be centrally cooled.

1. A rechargeable cell comprising an outer casing, a roll and a protective cap fitted onto a top of the outer casing, the roll comprising layers of active and insulator material disposed within the outer casing, wherein an active layer of material of said roll is electrically connected to a positive terminal within the protective cap, the rechargeable cell further comprising an externally accessible hollow core which enables central cooling of the rechargeable cell, the hollow core being externally accessible by means of an aperture in a base of the outer casing opposite the protective cap and a core insert, wherein the core insert is formed of an electrically conductive material, wherein the core insert is electrically connected to an active layer of material of said roll not electrically connected to the positive terminal, wherein the core insert provides an electrode of the rechargeable cylindrical cell, and wherein the core insert is electrically connected to the active layer of material along the entire axial length of the active layer of the roll.

2. A rechargeable cell according to claim 1 wherein the roll and/or the outer casing are at least substantially cylindrical in shape, such that the rechargeable cell is a rechargeable cylindrical cell.

3. A rechargeable cell according to claim 1 wherein the roll comprising layers of active and insulator material is formed around part of the core insert.

4. A rechargeable cell according to claim 1 wherein the core insert provides a negative electrode of the rechargeable cylindrical cell.

5. A rechargeable cell according to claim 1 wherein the roll comprising layers of active and insulator material is formed around a mandrel such that the roll comprises a central bore and wherein part of the core insert is inserted into that central bore and is not electrically connected to any layer of the roll.

6. A rechargeable cell according to claim 1 wherein the core insert comprises an elongate member and an insert base, wherein the elongate member is disposed in a central bore of said roll, and wherein the insert base is affixed to the base of the outer casing to seal the roll within the outer casing whilst facilitating access to the externally accessible hollow core thereby formed.

7. A rechargeable cell according to claim 6 wherein the elongate member is generally cylindrical and hollow, and is closed at an upper end thereof.

8. A rechargeable cell according to claim 7 wherein the upper end of the elongate member is crimped closed.

9. A rechargeable cell according to claim 1 wherein the core insert is formed from the same material as the outer casing of the rechargeable cell.

10. A rechargeable cell according to claim 1 wherein the core insert is formed from steel.

11. A rechargeable cell according to claim 6 wherein the insert base is welded to the base of the outer casing.

12. A rechargeable cell according to claim 1 wherein the core insert is formed, at least in part, from a plastics material.

13. A battery pack comprising a plurality of rechargeable cells according to claim 1.

14-23. (canceled)

24. A core insert for a rechargeable cell comprising a roll comprising layers of active and insulator material disposed within an outer casing, the core insert comprising an elongate member and an insert base, the elongate member being configured such that it can be disposed in a central bore of said roll, the insert base being affixable to a base of the outer casing for sealing said roll within the outer casing whilst facilitating access to an externally accessible hollow core thereby formed to enable central cooling of the rechargeable cell.

25. A core insert according to claim 24 wherein the elongate member is generally cylindrical and hollow, and is closed at an upper end thereof.

26. A core insert according to claim 25 wherein the upper end of the elongate member is crimped closed.

27. A core insert according to claim 24 wherein the core insert is formed from metal or plastics material.

28. A core insert according to claim 27 wherein the elongate member and the insert base of the core insert are a unitary construct.

29. A method of manufacture of a rechargeable battery cell, the method comprising:
(i) electrically connecting a core insert to an active layer of a material comprising layers of active and insulator material, the core insert being electrically connected to the active layer of material along its entire axial length, wherein the core insert provides a negative electrode of the rechargeable battery cell, the core insert having an elongate member that is closed at a first end thereof and has a base portion at a second end thereof;
(ii) winding said material about the core insert to form a roll and integral core insert;
(iii) inserting said roll and core insert, together as a single unit, into an outer casing having an aperture in a base thereof, such that the base portion of the core insert passes through said aperture; and
(iv) affixing the base portion of the core insert to the base of the outer casing to seal said roll within the outer casing and to form an externally accessible hollow core which enables central cooling of the rechargeable cell.

30. (canceled)

31. A method of manufacture of a rechargeable battery cell the method comprising:
(i) providing an outer casing having a base comprising an aperture;
(ii) positioning a roll of material comprising layers of active and insulator material into the outer casing;
(iii) inserting part of a core insert, having an elongate member and an insert base, into a central core of the roll; and
(iv) affixing said insert base to the base of the outer casing to form an externally accessible hollow core which enables central cooling of the rechargeable cell.

32. (canceled)
